(19) United States
(12) Patent Application Publication
(10) Pub. No.: US 2018/0293261 A1
(43) Pub. Date: Oct. 11, 2018

(54) METHODS AND SYSTEMS FOR STORING AND RETRIEVING DATA ITEMS

(71) Applicant: Doron BARACK, Kfar Sabah (IL)

(72) Inventor: Doron BARACK, Kfar Sabah (IL)

(21) Appl. No.: 15/480,391

(22) Filed: Apr. 6, 2017

(51) Int. Cl. G06F 17/30; G06F 3/06; H04L 29/08; G06F 21/62

(52) U.S. Cl. CPC G06F 17/30339; G06F 3/0604; G06F 3/0631; G06F 17/30569; G06F 3/0622; H04L 67/1097; G06F 21/6218; G06F 3/067

(57) ABSTRACT

Computerized methods and systems generate first and second data items from a source data item. The first data item includes a first subset of data of the source data item. The second data item includes a second subset of data of the source data item that is different from the first subset. Both of the first and second subsets of data are necessary to access the source data item. A first data storage medium stores the first data item, and a second data storage medium, remotely located from the first data storage medium, stores the second data item.

### TECHNICAL FIELD

The present invention relates to methods and systems for storing and retrieving data items.

### BACKGROUND OF THE INVENTION

Protection of information (i.e., data items) stored on electronic devices, for example, computers and computer systems, is paramount to ensure the proper functioning and use of such devices. Software, such as, for example, anti-virus, anti-spyware, anti-malware and firewalls, are depended upon by electronic device users for protecting against malware and other malicious attacks, which aim to disrupt device operations, gather sensitive information, or gain access to private assets residing in electronic devices via exfiltration techniques. However, such types of software do not afford protection in the event of theft or attempted use of electronic devices by unauthorized users. To safeguard against such threats, the information stored on electronic devices may be protected via encryption techniques, in which a secure key or password is required to decrypt and retrieve the information stored on an electronic device. However, an unauthorized user attempting to retrieve encrypted information may employ password and/or encryption cracking techniques and methods to circumvent the layer of encryption protection.

Clustered file systems, such as, for example, distributed file systems (DFS), typically employ multiple nodes or servers, connected over a network, to facilitate a shared file system functionality. A DFS, for example, may fragment files into multiple chunks of equal size (e.g., 60 megabytes each), and redundantly distribute those chunks across multiple nodes or servers. Such a DFS provides multiple clients, connected to the nodes or servers over the network, with access to the files or redundant chunks (i.e., fragments) of files stored on the nodes or servers by use of network protocols. Such DFS architectures provide a reduction in the overall traffic load of the system. However, such file systems, due in part to the chunk redundancy, may be susceptible to security breaches, resulting in exfiltration of entire files or groups of files from nodes or servers.

### SUMMARY OF THE INVENTION

The present invention is directed to computerized methods and systems, which store subsets of data from data items in multiple memory locations which are remote from each other, and retrieve the stored subsets from the multiple memory locations to form reconstructed versions of data items from which the subsets originate.

Embodiments of the present invention are directed to a method for storing data items. The method comprises: generating at least a first and a second data item from a source data item, the first data item including a first subset of data of the source data item and the second data item including a second subset of data of the source data item, the first and second subsets of data being different from each other, and both of the first and second subsets of data being necessary to access the source data item; and storing the first data item in a first data storage medium and the second data item in a second data storage medium that is remotely located from the first data storage medium.

Optionally, the first data storage medium is deployed on an endpoint client.

Optionally, the second data storage medium includes a remote server.

Optionally, the second data storage medium includes au external device operative to removably couple to the first data storage medium via a physical interface.

Optionally, the first subset of data includes a majority of data of the source data item.

Optionally, the second subset of data includes a minority of data of the source data item.

Optionally, the source data item includes header information, and wherein each of the first and second data items includes header information derived from the source data item header information.

Optionally, the method further comprises; reconstructing the source data item by combining at least a portion of data of the first data item with at least a portion of data of the second data item.

Embodiments of the present invention are directed to a computer system for storing data items. The computer system comprises: a storage medium for storing computer components; and a computerized processor for executing the computer components. The computer components comprise: a computer module configured for: generating at least a first and a second data item from a source data item, the first data item including a first subset of data of the source data item and the second data item including a second subset of data of the source data item, the first and second subsets of data being different from each other, and both of the first and second subsets of data being necessary to access the source data item; and storing the first data item in a first data storage entity and the second data item in a second data storage entity that is remotely located from the first data storage entity.

Optionally, the storage medium and the computerized processor are deployed on an endpoint client.

Optionally, the first data storage entity is deployed on the endpoint client.

Optionally, the computer system further comprises: a data storage medium deployed on the endpoint client, wherein the first data storage entity is implemented as the data storage medium.

Optionally, the computer system further comprises: a data item allocation table, installed on the endpoint client, that includes a memory address reference to the second data storage entity.

Embodiments of the present invention are directed to a method for reconstructing data items. The method comprises: receiving a request to access a first data item that includes a first subset of data of a source data item, the first data item being stored in a first data storage medium; identifying a second data item, based on the request to access the first data item, the second data item being stored in a second data storage medium remotely located from the first data storage medium, and the second data item including a second subset of data of the source data item that is different from the first subset of data, and both of the first and second subsets of data being necessary to reconstruct the source data item; verifying an authorization to access the first and second data items; and should access to both first and second data items be authorized, combining at least a portion of data of the first data item with at least a portion of data of the second data item to generate a reconstructed rendition of the source data item.

Optionally, the first data storage medium is deployed on an endpoint client.

Optionally, the identifying the second data item includes: analyzing a memory address reference to the second data storage medium.

Optionally, the method further comprises: modifying the reconstructed rendition of the source data item to generate a modified data item.

Optionally, the method further comprises: generating a new first and second data item from the modified data item, the new first data item including a first subset of data of the modified data item and the new second data item including a second subset of data of the modified data item; and storing the new first data item in the first data storage medium and the new second data item in the second data storage medium.

Optionally, the storing includes: overwriting the first data item with the new first data item, and overwriting the second data item with the new second data item.

Optionally, the method further comprises: establishing a data communication link between the first data storage medium and the second data storage medium.

Embodiments of the present invention are directed to a computer usable non-transitory storage medium having a computer program embodied thereon for causing a suitable programmed system to store data items, by performing the following steps when such program is executed on the system. The steps comprise: generating at least a first and a second data item from a source data item, the first data item including a first subset of data of the source data item and the second data item including a second subset of data of the source data item, the first and second subsets of data being different from each other, and both of the first and second subsets of data being necessary to access the source data item; and storing the first data item in a first data storage medium and the second data item in a second data storage medium that is remotely located from the first data storage medium.

Embodiments of the present invention are directed to a computer usable non-transitory storage medium having a computer program embodied thereon for causing a suitable programmed system to reconstruct data items, by performing the following steps when such program is executed on the system. The steps comprise: receiving a request to access a first data item that includes a first subset of data of a source data item, the first data item being stored in a first data storage medium; identifying a second data item, based on the request to access the first data item, the second data item being stored in a second data storage medium remotely located from the first data storage medium, and the second data item including a second subset of data of the source data item that is different from the first subset of data, and both of the first and second subsets of data being necessary to reconstruct the source data item; verifying an authorization to access the first and second data items; and should access to both first and second data items be authorized, combining at least a portion of data of the first data item with at least a portion of data of the second data item to generate a reconstructed rendition of the source data item.

This document references terms that are used consistently or interchangeably herein. These terms, including variations thereof, are as follows:

A “computer system” includes machines, computers and computing or computer systems (for example, physically separate locations or devices), servers, gateways, computer and computerized devices, processors, processing systems, computing cores (for example, shared devices), and similar systems, workstations, modules and combinations of the aforementioned. The aforementioned “computer” may be in various types, such as a personal computer (e.g., laptop, desktop, tablet computer), or any type of computing device, including mobile devices that can be readily transported from one location to another location (e.g., smartphone, personal digital assistant (PDA), mobile telephone or cellular telephone).

A “server” is typically a remote computer or remote computer system, or computer program therein, in accordance with the “computer system” defined above, that is accessible over a communications medium, such as a communications network or other computer network, including the Internet. A “server” provides services to, or performs functions for, other computer programs (and their users), in the same or other computer systems. A server may also include a virtual machine, a software based emulation of a computer or computer system.

A “data item” refers to objects that contain data elements which can be stored on a computer system, for example, in a memory or the like, and which may be propagated between a computer system and a peripheral device or memory, connected or linked to the computer system via a data connection or a network connection. Types of data items include files of different file types having file extensions which include, but are not limited to, *.doc, *.docx, *.xls, *.xlsx, *.ppt, *.pptx, *.pdf, *.rtf, *.txt, *.html, *.js, *.mht, *.tiff, *.bmp, *.jpg, *.gif, *.png, *.mp3, *.wav, *.m4a, *.avi, *.wmv, and *.mp4 file extensions.

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1 is a diagram illustrating a system environment in which an embodiment of the invention is deployed;

FIG. 2 is a diagram of the architecture of an exemplary system embodying the invention;

FIG. 3 is a flow diagram illustrating a process for storing data items according to an embodiment of the invention;

FIG. 4 is a flow diagram illustrating a process for retrieving data items according to an embodiment of the invention;

FIG. 5 is a diagram illustrating a system environment in which a further embodiment of the invention is deployed;

FIG. 6 is a diagram of the architecture of an exemplary system embodying the invention, installed on a remote computer system of the system environment of FIG. 5;

FIG. 7 is a diagram illustrating a system environment in which a further embodiment of the invention is deployed;

FIG. 8 is a diagram of the architecture of an exemplary system embodying the invention, installed on a computer system of the system environment of FIG. 7;

FIG. 9 is a diagram of the architecture of an exemplary system embodying the invention, installed on a remote computer system of the system environment of FIG. 7; and

FIG. 10 is a flow diagram illustrating a process for transmitting and receiving data items according to an embodiment of the invention.

### DESCRIPTION OF THE PREFERRED EMBODIMENTS

The present invention is directed to computerized methods and systems, which store subsets of data from data items in multiple memory locations which are remote from each other, and retrieve the stored subsets from the multiple memory locations to form reconstructed versions of data items from which the subsets originate. A data storage and retrieval module, preferably installed on a computer system, generates two or more data items from a source data item. Each of the generated data items includes a different subset of the data of the source data item. The data storage and retrieval module stores each of the generated data items in a different memory location, in which at least two of the memory locations are remote from each other. For example, one of the generated data items may be stored in a local memory of the computer system, and the other generated data items may be stored on a remote server (e.g., a cloud server) or an external data storage device (e.g., flash memory device, external hard disk drive, memory card, etc.). Neither of the memory locations have stored thereon all of the subsets of data of the source data item. There exists a one-to-one relationship between each generated data item and the memory location on which the generated data item is stored. To access a source data item, the data storage and retrieval module accesses the generated data items, stored in the different memory locations, and combines the data in those generated data items to reconstruct the source data item.

Before explaining at least one embodiment of the invention in detail, it is to be understood that the invention is not necessarily limited in its application to the details of construction and the arrangement of the components and/or methods set forth in the following description and/or illustrated in the drawings and/or the examples. The invention is capable of other embodiments or of being practiced or carried out in various ways.

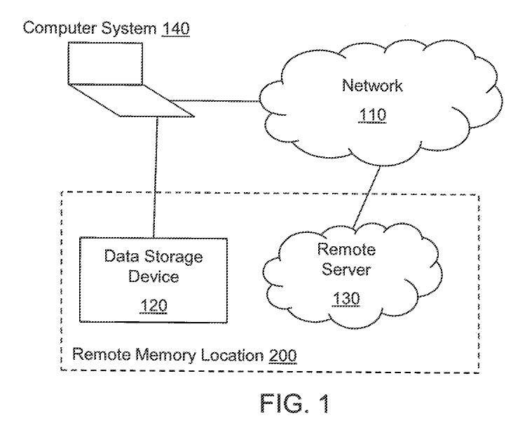

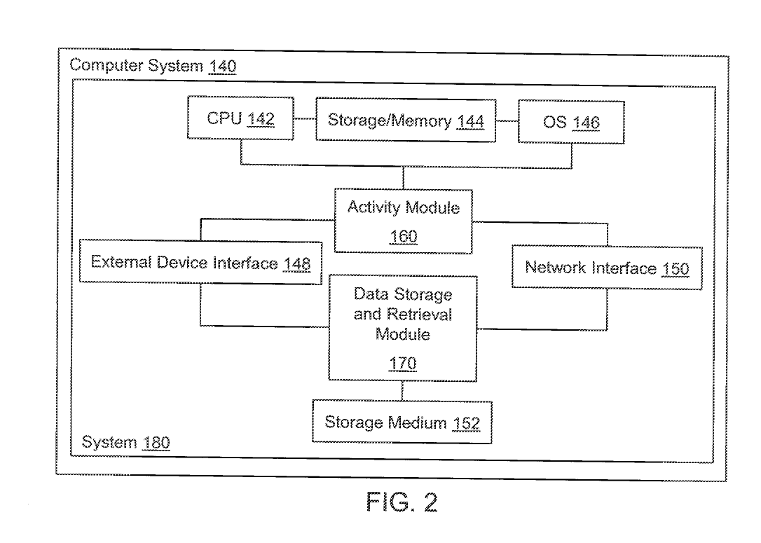

Refer now to FIG. 1, an illustrative example environment in which embodiments of the present disclosure may be performed. Some of the embodiments of the present disclosure may be performed over a network 110, while other embodiments of the present disclosure may be performed in a non-networked setting. The embodiments include a system 180 (FIG. 2), including, for example, a data storage and retrieval module 170, on a computer system 140, which in certain embodiments is linked to the network 110. In such embodiments, the network 110 may be formed of one or more networks, including for example, the Internet, cellular networks, wide area, public, and local networks. Examples of the computer system 140 include, but are not limited to, an endpoint client (e.g., a user computer), a file storage computer system, a computer cluster, a mobile communication device (e.g., smartphone), and a group of computers constituting an enterprise which are linked via private network (i.e., Intranet).

The data storage and retrieval module 170 facilitates the storage and retrieval of data items. The storage of data items is effectuated by decomposing, dividing, splitting, fragmenting, or otherwise partitioning a data item into multiple subsets of data, and storing those subsets of data, as new data items, in multiple separate memory locations. The retrieval of data items is effectuated by retrieving the new data items, containing the multiple subsets of data, from the multiple memory locations and combining those subsets of data to effectively reconstruct the original data item from which the subsets of data were generated.

Embodiments of the present disclosure are preferably performed by storing at least one of the subsets of data in a local memory of the computer system 140, and at least one of the other subsets of data in a remote memory location 200 which is remotely located from the computer system 140. Within the context of this document, two memory locations are considered to be remote from each other if the two memory locations are installed and/or operate on separate electronic devices. The remote memory location 200 is also considered to be a memory location that is external to the computer system 140.

In embodiments of the present disclosure which are performed over the network 110, at least one of the remote memory locations 200 is a remote server 130, which is a networked data storage location, implemented, for example, as a cloud server. The remote server 130 may be accessible to the computer system 140 via a web server or servers (not shown) which provides the subsets of data (in the form of data packets) to the remote server 130 for storage. Such web servers allow access, by the computer system 140, to web sites hosted by host servers, such as the remote server 130. The networked transmission of the subsets of data (in the form of data packets) between the computer system 140 and the remote server 130 may be facilitated by a web browser (not shown) installed on the computer system 140. Such a web browser may be any web browser used on computers and computer systems for accessing data on the world-wide web, such as, for example, Microsoft® Internet Explorer® car Mozilla Firefox®. Alternatively, the networked transmission of subsets of data may be performed based on a client sharing network, using appropriate file sharing protocols, as will be described in subsequent sections of the present disclosure.

In embodiments of the present disclosure which are performed in a non-networked setting, at least one of the remote memory locations 200 is a data storage device 120, that is removably interfaced with, and is external to, the computer system 140. Examples of devices which may be used to implement the data storage device 120 include, but are not limited to, flash memory devices (e.g., USB flash drives), external hard disk drives, and memory cards (e.g., secure digital cards, compact flash cards, memory sticks, etc.).

The data storage and retrieval module 170 includes software, software routines, code, code segments and the like, embodied, for example, in computer components, modules and the like, that are installed on machines, such as the computer system 140. For example, the data storage and retrieval module 170 performs an action when a specified event occurs, as will be further detailed below. The data storage and retrieval module 170 may be instructed to perform such actions by a user of the computer system 140, or by an administrator of the computer system 140, for example if the computer system 140 is realized as part of an enterprise operating on a private network (i.e., Intranet). In certain embodiments, particularly in those embodiments performed in a non-networked setting, the data storage and retrieval module 170 may include software, software routines, code, code segments and the like, embodied, for example, in computer components, modules and the like, that are installed on devices representative of the remote memory location 200, for example, the data storage device 120.

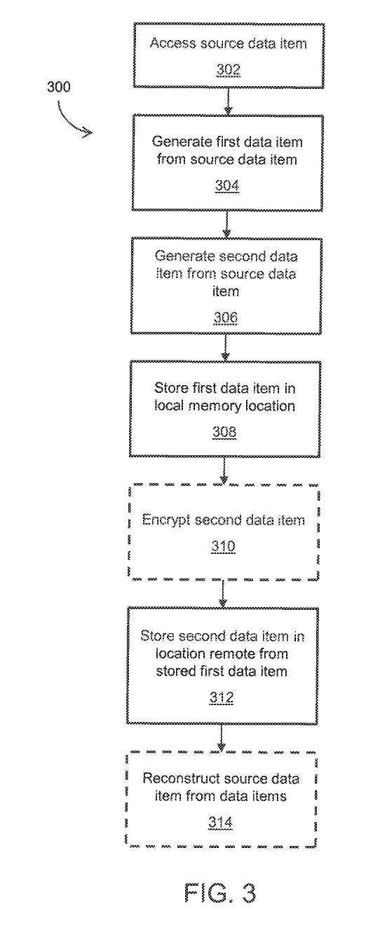

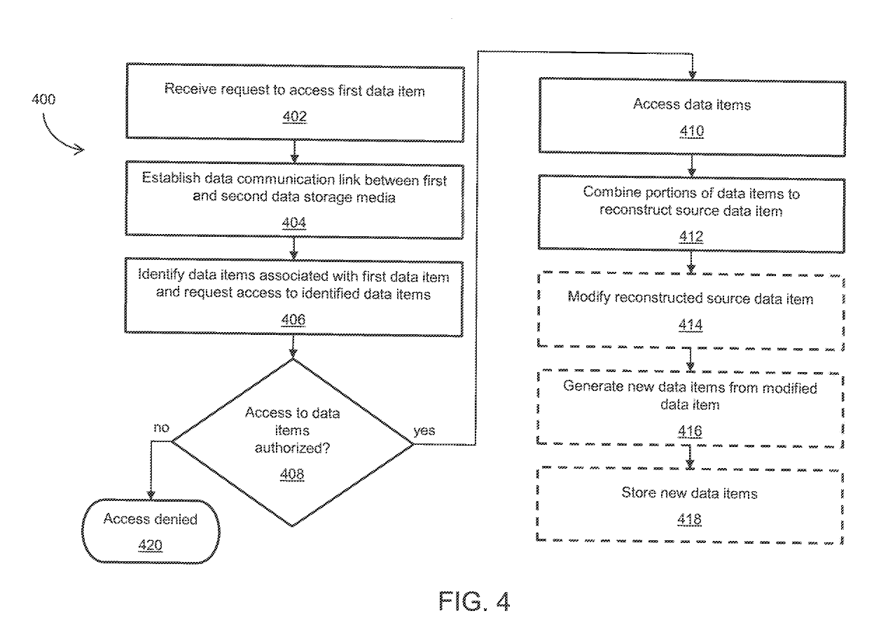

FIG. 2 shows the computer system 140 and the system 180 therein, as an architecture, with the data storage and retrieval module 170 incorporated into the system 180 of the computer system 140. The system 180 is referred to as “the system” in the description of FIGS. 3 and 4 below. All components of the computer system 140 and/or the system 180 are connected or linked to each other (electronically and/or data), either directly or indirectly.

Initially, the computer system 140 includes a central processing unit (CPU) 142, a storage/memory 144, an operating system (OS) 146, an external device interface 148, and a network interface 150. The processors of the CPU 142 and the storage/memory 144, although shown as a single component for representative purposes, may be multiple components.

The CPU 142 is formed of one or more processors, including microprocessors, for performing the computer system 140 functions, including executing the functionalities and operations of the data storage and retrieval module 170, as detailed herein, the OS 146, and including the processes shown and described in the flow diagrams of FIGS. 3 and 4. The processors are, for example, conventional processors, such as those used in servers, computers, and other computerized devices. For example, the processors may include x86 Processors from AMD and Intel, Xeon® and Pentium® processors from Intel, as well as any combinations thereof.

The storage/memory 144 is any conventional storage media. The storage/memory 144 stores machine executable instructions for execution by the CPU 142, to perform the processes of the present embodiments. The storage/memory 144 also includes machine executable instructions associated with the operation of the components, including the data storage and retrieval module 170, and all instructions fir executing the processes of FIGS. 3 and 4, detailed herein.

The OS 146 includes any of the conventional computer operating systems, such as those available from Microsoft of Redmond Wash., commercially available as Windows® OS, such as Windows® XP, Windows® 7, MAC OS from Apple of Cupertino, Calif., or Linux. Without loss of generality, and for the purposes of illustrating the computerized methods and systems disclosed herein, the subsequent sections of the present disclosure are described with respect to the OS 146 of the computer system 140 being a Windows® OS. As should be understood to one of ordinary skill in the art, the subsequent sections of the present disclosure could analogously be described with respect to the OS 146 of the computer system 140 being a non-Windows® OS.

Activity that occurs on the computer system 140 is logged and managed by an activity module 160 on the computer system 140. In particular, the activity module 160 is configured to sense changes that occur on the computer system 140. Examples of activity sensed by the activity module 160 may include, but is not limited to, file accesses, network accesses, application accesses, registry accesses, file creations, file modifications, process calls and process creations. Accordingly, when a process requests access to a file or other data item from the OS 146, the access request is propagated to the activity module 160 by the OS 146, allowing the data storage and retrieval module 170 to view file access requests by processes created or executed on the computer system 140. In other words, the data storage and retrieval module 170 retrieves and/or receives file access events from the activity module 160.

For computers running a Windows® OS, the activity module 1.60 can be implemented as a file system filter driver (FSFD). The FSFD is a driver that adds value to or modifies the behavior of the file system of the computer system 140. For example, the FSFD can filter input/output (I/O) operations for one or more file systems or file system volumes. The filtering executed by the FSFD can include, but is not limited to, logging, observing, modifying or preventing I/O operations.

The external device interface 148 is a physical interface which provides a data communication link between the computer system 140 and peripheral devices, such as the data storage device 120. Examples of interfaces which may be used to implement the external device interface 148 include, but are not limited to, USB ports and memory card slots. The network interface 150 is a physical, virtual, or logical data link for exchanging packets with the network 110, and more particularly, with the remote server 130.

The storage medium 152 may be any type of conventional storage medium used for storing files and information on computers and computer systems. Such conventional storage mediums used for implementing the storage medium 152 are typically non-volatile memory, such as, for example, hard disk drives, solid state drives, and the like.

The data storage and retrieval module 170 may be, for example, software which runs as a background process executed by the OS 142, in conjunction with the activity module 160. A data item, which under conventional circumstances, would be stored in a storage medium of the computer system 140, is instead manipulated and/or operated on by the data storage and retrieval module 170 to decompose, divide, split, fragment, or otherwise partition the data item into at least two different subsets of data, and store one of the subsets in the storage medium 152 and store at least one of the other subsets of data in the remote memory location 200 that is remotely located from the storage medium 152.

Within the context of the document, the terms “source data item” and “original data item” refer interchangeably to a data item from which the two or more subsets (i.e., portions) of data are generated.

For clarity of illustration, the remaining sections of the present document will describe the embodiments of the present disclosure with respect to the partitioning of a data item into two subsets of data. Such description should not be taken to limit the partitioning of data items into strictly two subsets of data, as partitioning of a data item into more than two subsets (e.g., three or more subsets) is possible.

As is known in the art, data items include data item information (e.g., header data, metadata, etc.) and data content itself, and may retain the header information and data in various structured formats, such as, for example, chunk-based formats. The structured format of a data item typically retains all data in a series of information segments, such as, for example, bits or bytes of information. For example, PDF file types (i.e., files having a *.pdf file extension) are typically 7-bit ASCII files which may optionally include elements having binary content. As an additional example, DOC file types (i.e., files having a *.doc file extension) are binary files made up of a sequence of bytes (i.e., 8-bit groups), whereas DOCX file types (i.e., files having a *.docx file extension) are based on XML file formats.

The header information of a data item is typically placed at the beginning of the data item, and therefore may correspond to a first group of bits or bytes. Additional identifying information of a data item may be placed in other sections of the data item, for example at or towards the end of the data item.

In an exemplary series of processes to protect and store data items, the system 180 operates on a source data item to generate two (or more) data items. The first generated data item includes a first subset of the data of the source data item, and the second generated data item includes a second subset of the data of the source data item. The two subsets of data are different from each other, and as a result, neither of the generated data items includes the complete data of the source data item. In other words, the two generated data items are perceived as two different incomplete versions of the source data item. In addition, both subsets of data (i.e., both first and second data items) are required in order to access (i.e., reconstruct) the source data item. Preferably, one of the generated data items includes a disproportionate amount of the data from the source data item, relative to the other of the generated data items. As a result, the two generated data items preferably have different sizes and therefore occupy different amounts of memory. For example, the first subset of data (i.e., the portion of data of the source data item included in the first generated data item) may include a majority portion of the data of the source data item, while the second subset of data (i.e., the portion of data of the source data item included in the second generated data item) may include a minority portion of the data of the source data item.

In a non-limiting illustrative example, consider a source data item having a structured format consisting of 8-bytes, with each byte having 8-bits. The first byte (i.e., byte 1) of the source data item includes all header data and metadata and no data content, with the remaining 7-bytes (i.e., bytes 2-8) of the source data item used to store the data content of the data item. In performing the data item storing process, the system 180 may generate the first data item by selecting bytes 2-7 of the source data item as the first subset of data, and may generate the second data item by selecting the byte 8 (i.e., the last byte) of the source data item as the second subset of data. The header data and metadata in the byte 1 of the source data item may then be used by the system 180 to generate header data and metadata for the first and second data items. As a result, the first data item is a 6-byte data item (plus a header byte including header data and metadata) and the second data item is a 1-byte data item (plus a header byte including header data and metadata).

The system 180 preferably generates information which associates the generated data items with each other. The generated information associating the generated data items provides an indication as to which subsets of the data of the source data item are included in which of the generated data items, and facilitates the reconstruction of the source data item from the generated data items. Such information associating the generated data items with each other may be stored in the data items themselves, and may also be logged (e.g., by the activity module 160) and stored in a memory or database on the computer system 140, as a table or file. The generated information associating the generated data items with each other also preferably includes information pertaining to the structure and content of the source data item, such as, for example, checksum information. For example, prior to generating the two data items from the source data item, a checksum of the source data item may be obtained by inputting the source data item into a checksum function. The checksum output, as well as the checksum function, is preferably included in the information generated information associating the generated data items with each other. Note that the source data item and the (two) generated data items will yield (three) distinctly different checksum values when used as input into the same checksum function.

The association of the generated data items may be effectuated by including header information derived from the source data item in the header information of the two generated data items. For example, the header information of the generated data items may include header data derived from the header data of the source data item. Alternatively, or in addition, the header information of the generated data items may include metadata derived from the metadata of the source data item. In this way, when the system 180 reads the header information of a generated data item, the system 180 is provided with an indication as to what portion of that data item was derived from a source data item, as well as which other generated data items contain any remaining portions of data derived from the same source data item. Note that the header information included in the second data item may also include user specific identification information.

Alternatively, or in addition, the association of the generated data items may be effectuated by creating a listing of all generated data items derived from the same source data item, as well as a mapping of which portions of those generated data items corresponding to which subsets of data of the source data item. Such a listing may be retained in a file stored in the storage medium 152 or another memory of the computer system 140 that is linked to the storage medium 152. Alternatively, such a listing may be retained in a structured storage format, such as, for example, a database (not shown) on the computer system 140 that is linked to the storage medium 152.

In a non-limiting implementation, the system 180 may generate the two data items by copying relevant portions of the data in the data fields of the source data item into two new data items, and subsequently removing the source data item from the storage medium 152. In an alternative non-limiting implementation, a portion of the data in the data fields of the source data item may be removed from the source data item and copied into a new data item. The removal of data from the source data item results in the generation of the first data item, while the copying of the removed data into the new data item results in the generation of the second data item.

The system 180 then stores (i.e., saves) the two generated data items in different memory locations which are remotely located from each other, with each generated data item being stored in only a single one of the memory locations. For example, the first data item may be stored locally on the computer system 140 in the storage medium 152, and the second data item may be stored in the remote memory location 200 that is remotely located from (i.e., external to) the storage medium 152. Prior to storing the generated data items, the system 180 may optionally encrypt any or all of the generated data items. In embodiments of the present disclosure performed over the network 110, the process for storing the second data item in the remote memory location 200 includes uploading the second data item to the remote server 130, via the network 110.

Preferably, the generated data item that includes the majority portion of data of the source data item (i.e., the first data item) is stored in the storage medium 152, and the generated data item that includes the minority portion of data of the source data item (i.e., the second data item) is stored in the memory location remote from the storage medium 152. As such, the amount of data stored in the remote memory location 200 is small relative to the amount of data stored in the storage medium 152. Preferably, the size of the generated data item stored in the storage medium 152 is several times larger than the size of the generated data item stored in the remote memory location 200, and is more preferably at least one order of magnitude larger. For example, if the source data item is a 100-megabyte file, the size of the generated data item stored in the storage medium 152 may be approximately 99.5 megabytes (i.e., 99,500 kilobytes) or larger, and the size of the generated data item stored in the remote storage medium 200 may be 500 kilobytes or smaller.

As a result of the processes, executed by the system 180, to store data items generated from a source data item, each of the storage locations (i.e., the storage medium 152 and the remote memory location 200) has a generated data item, corresponding to a different subset of data of the source data item, stored thereon. Furthermore, neither of the storage locations (i.e., the storage medium 152 and the remote memory location 200) has stored thereon all of the subsets of data of the source data item necessary for accessing (i.e., opening) the source data item. For example, if the storage medium 152 has the first data item (including the majority portion of data of the source data item) stored thereon, the storage medium 152 does not have the second data item (including the remaining minority portion of data of the source data item) stored thereon. Similarly, if the remote memory location 200 has the second data item (including the remaining minority portion of data of the source data item) stored thereon, the remote memory location 200 does not have the first data item (including the majority portion of data of the source data item) stored thereon.

As mentioned above, there exists a one-to-one relationship between each generated data item and the storage location on which the generated data item is stored. Accordingly, as a result of the processes, executed by the system 180, to store data items generated from a source data item, each of the generated data items is stored in a unique one of the storage locations (i.e., the storage medium 152 and the remote memory location 200), such that each generated data item is stored only in a single storage location. In other words, the generated data items are not stored redundantly. Continuing with the example above, if the storage medium 152 has the first data item (including the majority portion of data of the source data item) stored thereon, the first data item is not stored on any other non-volatile storage medium accessible by the system 180 (e.g., the remote memory location 200). Similarly, if the remote memory location 200 has the second data item (including the remaining minority portion of data of the source data item) stored thereon, the second data item is not stored on any other non-volatile storage medium accessible by the system 180 (e.g., the storage medium 152).

The data storage and retrieval module 170 may be implemented as part of the file system of the computer system 140, which controls the storage and retrieval of data. For example, in computer systems using a File Allocation Table (FAT) as the file system, the data storage and retrieval module 170 may be implemented as part of the FAT. As such, the system 180 may include, for a particular source data item, a memory address reference (i.e., pointer) in the file system (e.g., FAT, etc.) to the local and remote memory locations which store the relevant data items generated from the source data item. Note that typical implementations of the data storage device 120 (e.g., flash memory devices, external hard disk drives, memory cards, etc.) utilize FAT as the file system architecture. As such, in embodiments of the present disclosure which utilize the data storage device 120 to store one or more of the incomplete portions, the data storage and retrieval module 170 may communicate with the FAT of the data storage device 120 to include a reference in the FAT of the data storage device 120 to the storage locations of the data items generated from a given source data item.

In embodiments of the present disclosure performed over the network 110, the memory address reference (i.e., pointer) to the remote memory location may include an IP address of the remote server 130.

Note that although the functionality of the system 180 has thus far been described within the context of storing data items generated from a single source data item, the system 180 is advantageously used for generating and storing data items from a large array of source data items. The source data items from which subsets of data are generated, and subsequently stored in the storage medium 152 and the remote memory location 200, may be selected according preferences set by a user (or administrator) of the computer system 140. For example, a user of the computer system 140 may select specific source data items (i.e., files) for storing using the methodology of the data storage and retrieval module 170 described above. The selection of specific data items may be facilitated by the user of the computer system 140 individually selecting source data items or types of data items, or may be facilitated by selecting file directories for which all data items located in the file directory library are stored using the methodology of the data storage and retrieval module 170.

The data item storage and retrieval processes performed by the system 180 may be modified or adjusted according to several parameters, preferably configurable by a user or administrator of the computer system 140. Examples of such parameters include, but are not limited to, the sizes of the generated data items relative to the source data item (which may be indicated, for example, by a percentage), selection of which source data items to store/retrieve using the data storage and retrieval module 170, selection of the remote memory location 200 as the data storage device 120 for certain data items, selection of the remote memory location 200 as the remote server 130 for certain data items, priority settings which prioritize certain file directories, priority settings which prioritize certain data item types, and encryption settings for encrypting generated data items.

The user configurable parameters also preferably include creation or modification of a password, used for verifying if access requests to generated data items is authorized during retrieval of generated data items. The password may be created and set by a user (or administrator) of the computer system 140 during or prior to the generating of the data items from the source data item. The password may be user specific, and may be applied to subsets of source data items.

Preferably, the information, generated by the system 180, that associates the generated data items with each other, also includes some or all of the configuration parameters set by the user of the computer system 140, such as, for example, encryption level settings for the generated data items, the decryption key for decrypting the encrypted data items, the source data item checksum, and the checksum function used for obtaining the source data item checksum.

In an exemplary series of processes to retrieve a data item, the system 180 first receives a request to access one of the generated data items. Since the first generated data item is locally stored on the computer system 140, for example, in the storage medium 152, the access request is typically directed to the first generated data item. The access request may originate from a user of the computer system 140, or an administrator of the computer system 140. In operation, the access request may be initiated by common methods used to open files on computer systems using peripheral hardware devices (e.g., mouse, keyboard, etc.) connected to the user computer 140. For example, if the OS 146 of the computer system 140 is a Windows® OS the access request may be initiated by the user pointing the mouse cursor over the relevant data item (i.e., file) and double-clicking to open the file. For example, the typical process flow, on a computer system running Windows® OS, for opening a DOC file type includes the process userinit.exe calling, explorer.exe, which in turn calls winword.exe (i.e., an instance of the Microsoft® Word payload application) to open the DOC file.

Some of the steps in the series of processes for retrieving of data items, as performed by the system 180, are preferably transparent to the user of the computer system 140. As such, the request to access one of the generated data items (i.e., an access event) is logged and managed by the activity module 160, which provides the access event to the data storage and retrieval module 170. The data storage and retrieval module 170 identifies the remote memory location of the remotely stored generated data item corresponding to the requested data item, which as mentioned above, may be included as a reference in the file system (e.g., FAT, etc.) of the computer system 140. The information associating the generated data items with each other is also provided to the data storage and retrieval module 170, based on the access request.

The system 180 may also verify the presence of a data communication link between the computer system 140 and the remote memory location 200. For example, if the remote memory location is the data storage device 120, the system 180 verifies that the data storage device 120 is connected to the computer system 140 via the external device interface 148. Alternatively, if the remote memory location is the remote server 130, the system 180 verifies that the computer system 140 is connected to the remote server 130 aver the network 110, via the network interface 150.

If the data communication link between the computer system 140 and the remote memory location is established, the system 180 then verifies whether access to the generated data items is authorized. The verification for authorization may include prompting the user (or administrator) of the computer system 140 with a password for accessing the requested data item (created as part of the configurable parameters of the system 180), and verifying that the password entered by the user (or administrator) of the computer system 140 matches the required password. The verification for authorization may also include certification information.

Upon verifying authorization to access the generated data items, the system 180 accesses the generated data items. In embodiments of the present disclosure performed over the network 110 (i.e., if the remote memory location 200 is the remote server 130), the process for accessing the generated data item stored on the remote server 130 includes downloading the generated data item from the remote server 130 to the computer system 140, via the network 110.

Subsequent to accessing the generated data items, the system 180 combines portions of the generated data items to reconstruct the source data item from which the generated data items were created. Consider the above described non-limiting illustrative example of a first 6-byte data item (plus a header byte including header data and metadata) data item and a second 1-byte data item (plus a header byte including header data and metadata) data item being generated from an 8-byte source data item. In such an example, the non-header bytes of the first data item are combined, via, for example, concatenation, with the non-header bytes of the second data item. The resultant combination is a 7-byte data item consisting of data content, to which an additional header byte, consisting of header data and metadata, can be added, yielding an 8-byte reconstructed rendition of the 8-byte source data item.

The system 180 may generate a checksum value for the reconstructed source data item by using the reconstructed data item as input to the checksum function used to generate the checksum value of the source data item. If the checksum value of the reconstructed source data item does not match the checksum value of source data item, the system 180 may provide an indication to the user (or administrator) of the computer system 140 that a reconstruction error occurred while attempting to reconstruct the source data item from the generated data items.

Note that the majority of actions performed during the process of combining generated data items to reconstruct a source data are transparent to the user of the computer system 140. Accordingly, from the perspective of the user (or administrator) of the computer system 140, accessing (i.e., opening) a data item is performed by requesting access to the generated data item stored in local memory (i.e., in the storage medium 152) by, for example, double-clicking on that data item. In response to the access request, the system 180 prompts the user of the computer system 140 for a password. The password prompt, from the perspective of the user, may be viewed as a standard file protection password. However, as described above, the system 180 performs several background processes to authenticate the requested access, and to combine relevant data items based on the access request.

Attention is now directed to FIG. 3 which shows a flow diagram detailing a computer-implemented process 300 in accordance with embodiments of the disclosed subject matter. This computer-implemented process includes an algorithm for generating data items from source data items, and storing the generated data items. Reference is also made to the elements shown in FIGS. 1-2. The process and sub-processes of FIG. 3 are computerized processes performed by the system 180, including, for example, the CPU 142 and associated components, such as the data storage and retrieval module 170. The aforementioned processes and sub-processes are for example performed automatically, but can be, for example, performed manually, and are performed, for example, in real-time.

The process 300 begins at block 302, where a source data item, selected, for example, according to preferences set by a user (or administrator) of the computer system 140, is accessed by the system 180 in order to decompose, divide, split, fragment, or otherwise partition the source data item into two subsets of data. The system 180 reads the header and data content of the source data item, and determines the structured format of the source data item. Information pertaining to the structured format of the source data item may then be logged, for example, by the activity module 160 as instructed by the system 180, and stored in a memory or database of the computer system 140. Note that the source data item may reside in volatile memory (e.g., RAM) of the computer system 140. As is known in the art, data items residing in volatile memory are removed from such memory upon reboot or power loss.

The process 300 then moves to block 304, where the system 180 performs actions to generate a first data item from the source data item. As discussed above, the first data item preferably includes a subset of the data of the source data item that includes a majority portion of the data of the source data item. The first data item also includes header data and metadata derived from the header data and metadata of the source data item. The process 300 then moves to block 306, where the system 180 performs actions to generate a second data item from the source data item. As discussed above, the second data item preferably includes a subset of the data of the source data item that includes a minority portion of the data of the source data item. The second data item also includes header data and metadata derived from the header data and metadata of the source data item. As mentioned above, the exact proportions of the subsets of the data contained in the generated data items may be selected in accordance with user configured parameters of the system 180.

Note that the generated data items may reside in volatile memory (e.g., RAM) of the computer system 140, along with the source data item.

The process 300 then moves to blocks 308, where the system 180 stores the first data item (generated in block 304) in a local memory of the computer system 140, preferably in the storage medium 152. The action performed by the system 180 in block 308 causes the file system of the computer system 140 (e.g., FAT, etc.) to create a reference (i.e., pointer) to the memory address and memory location where the first data item is stored.

The process 300 then moves to block 312, where the system 180 stores the second data item (generated in block 306) in the remote memory location 200. As mentioned above, the user (or administrator) of the computer system 140 may select the remote memory location 200 to be the data storage device 120 or the remote server 130 for the second data item. If the remote memory location 200 is selected as the remote server 130, the storing of the second generated data item includes uploading of the second generated data item to the remote server 130. The action performed by the system 180 in block 312 causes the file system of the computer system 140 (e.g., FAT, etc.) to create a reference to the memory location where the second data item is stored. Prior to performing the storing action of block 312, a data communication link, between the computer system 140 and the remote memory location 200 in which the second data item is to be stored, should be established via the external device interface 148 or the network interface 150.

Note that the system 180, subsequent to performing the generating action of block 306 and prior to performing the storing action of block 312, may optionally move to block 310 to encrypt the second data item, according to encryption level settings, which may be configured by the user (or administrator) of the computer system 140. As should be apparent, the system 180 may also encrypt the first data item subsequent to performing the generating action of block 304 and prior to performing the storing action of block 306.

As should be apparent to one of skill in the art, the execution of the actions performed in some of the blocks 304-312 may be performed in parallel or in an order different from the order illustrated in FIG. 3. For example, the system 180 may generate the first and second data items (i.e., execute blocks 304 and 306) in parallel (i.e., concurrently). Alternatively, for example, the system 180 may generate the second data item before generating the first data item (i.e., execute block 306 before block 304). In addition, for example, the system 180 may store the first and second data items (i.e., blocks 308 and 312) in parallel (i.e., concurrently).

As a result of the execution of the actions of blocks 304-312, the generated data items (i.e., the first and second data items) are stored in separate memory locations which are remotely located from each other. Accordingly, none of the memory locations have all of the subsets of data of the source data item, necessary for accessing the source data item, stored thereon. Both of the first and second data items are necessary (i.e., required) to allow the user of the computer system 140 to access the source data item from which the first and second data items are generated.

Note that as a result of the execution of blocks 308 and 312, the source data item may be removed from volatile memory of the computer system 140, or the source data item may be naturally removed from volatile memory upon rebooting of the computer system 140.

The process 300 may then optionally move to block 314, where the system 180 accesses and reconstructs the source data item from the generated data items. The process for accessing and reconstructing a source data item, from generated data items stored in memory locations which are remote from each other, is described in detail with reference to FIG. 4.

Attention is now directed to FIG. 4 which shows a flow diagram detailing a computer-implemented process 400 in accordance with embodiments of the disclosed subject matter. This computer-implemented process includes an algorithm for reconstructing data items (i.e., a source data item) from data items generated from a source data which are stored in memory locations that are remote from each other. Reference is also made to the elements shown in FIGS. 1-3. The process and sub-processes of FIG. 4 are computerized processes performed by the system 180, including, for example, the CPU 142 and associated components, such as the data storage and retrieval module 170. The aforementioned processes and sub-processes are for example performed automatically, but can be, for example, performed manually, and are performed, for example, in real-time.

The process 400 begins at block 402, where the system 180 receives a request to access (i.e., open) one of the generated data items (i.e., the first data item). As mentioned above, the access request is typically initiated by a user (or administrator) of the computer system 140 attempting to open a file, for example, by mouse double-clicking on a file. The user of the computer system 140 may request access to a generated data item stored in local memory (i.e., in the storage medium 152) of the computer system 140, or may request access to a generated data item stored in the remote memory location 200. For clarity of illustration, the steps performed by the process 400 will be described within the context of the user (or administrator) of the computer system 140 requesting access to a generated data item stored in local memory (i.e., in the storage medium 152) of the computer system 140.

The process 400 then moves to block 404, where a data communication link between the computer system 140 and the remote memory location 200 is established. The establishment of the data communication link may be performed manually. For example, in embodiments of the present disclosure performed in a non-networked setting, the data communication link may be established by the user connecting the data storage device 120 to the computer system 140 via the external device interface 148. Alternatively, in embodiments of the present disclosure performed over the network 110, the data communication link may be established by browsing (via a web browser installed on the computer system 140) to a remote storage web site hosted by the remote server 130. Note that the establishment of the data communication link may be performed automatically, and may be performed prior to block 402.

The process 400 then moves to block 406, where the system 180 identifies other data items, associated with the first generated data item, that were generated from the same source data item as the first data item. For example, as a result of the execution of block 406, the system 180 identifies the second data item that was generated from the same source data item as the first data item. As mentioned above, since the first generated data item is stored in local memory (i.e., in the storage medium 152) of the computer system 140, the second generated data item is stored in the remote memory location 200. The actions performed by the system 180 in block 406 involve analyzing the information associating the generated data items with each other. As mentioned above, this information may be logged, for example, by the activity module 160 (as directed by the data storage and retrieval module 170), and provides an association between the first data item generated from a source data item and the corresponding second data item generated from the source data item. For example, such analyzing may include analyzing logged listings, in the form of files, tables or database entries, of all generated data items derived from the same source data item. The analyzing performed in block 406 may also include reading header information in the first data item that provides identification information of the second generated data item.

As a result, in response to the access request initiated in block 402, the system 180 obtains identification information of the second generated data item. The system 180 also obtains memory location information of the second data item, by analyzing a memory address reference (i.e., pointer), in the file system (e.g., FAT, etc.) of the computer system 140, to the remote memory location 200 on which the second generated data item is stored.

Once the second data item is identified, based on the access request to the first data item, the system 180 requests access to the identified second data item, by requesting memory read access to the memory address location of the second data item.

The process 400 then moves to block 408, where the system 180 analyzes the access requests to both the first and second data items to verify if the user that initiated the access request is authorized to access the requested data items. The process of verifying authorization may include initially prompting the user (or administrator) of the computer system 140 for a password, which may be configured by the user (or administrator) during parameter set-up and configuration of the system 180, as described in previous section of the present disclosure. If the access request is not authorized by the system 180, for example, if the password entered by the user (or administrator) does not match the required password, the process 400 moves to block 420, where access to the requested data items is denied. Note that although not illustrated in FIG. 4, from block 420 the system 180 may re-prompt the user for the correct password, providing the user with subsequent attempts to enter the correct password, and allowing the system 180 to verify if the access request is authorized. Also, note that after a certain number of incorrect password entries, the user may be prevented from accessing the requested data item, or any other data items, for a set period of time.

As a result of the execution of block 420, the full source data item is not accessible to the computer system 140, and in the event of theft or loss of the computer system 140, only the first data item (which is an incomplete portion of the source data item) is obtainable from the storage medium 152. Furthermore, in the event of malware infection in which data items are exfiltrated from the computer system 140, only the first generated data items are exfiltrated (i.e., incomplete portions of the source data items), resulting the exfiltration destination receiving incomplete portions of data items.

If the access request is authorized by the system 180, for example, by verifying that the password entered by the user (or administrator) of the computer system 140 matches the password created as part of the configurable parameters of the system 180, the process 400 moves to block 410, where the generated data items are accessed by the system 180. The system 180 also checks if any of the accessed first or second data items have been encrypted or altered in any way, and performs a reverse operation on such alterations as part of the operations performed in block 410. For example, if the second data item was encrypted (as in block 310 of FIG. 3) prior to storing in the remote memory location 200, the system 180 may decrypt the encrypted second data item in block 410. The decryption of the generated data items may be facilitated by reading the decryption key information that is included as part of the information, generated by the system 180, that associates the generated data items with each other.

The process 400 then moves to block 412, where the system 180 operates on the accessed first and second data items to reconstruct the source data item from which the first and second data items were generated.

The operations performed by the system 180 in block 412 include determining which portions of data in the first and second data items should be combined together to render the reconstructed source data item. As mentioned above, the system 180 may analyze the information associating the generated data items with each other by analyzing files or database information mappings which portions of data in the first and second data items correspond to which subsets of data of the source data item. In this way, the system 180 is able to combine, for example, via concatenation, those subsets of data to effectively generate a reconstructed rendition of the source data item from which the subsets of data (i.e., the first and second data items) were generated.

The operations performed by the system 180 in block 412 may also include generating a checksum value for the reconstructed source data item by using the reconstructed data item as input to the checksum function used to generate the checksum value of the source data item. As mentioned above, the checksum function and checksum value of the source data item are preferably included in the information associating the generated data items with each other. Although not shown in FIG. 4, if the checksum value of the reconstructed source data item does not match the checksum value of source data item, the system 180 may provide an indication to the user (or administrator) of the computer system 140 that a reconstruction error occurred while attempting to reconstruct the source data item from the generated data items.

If the checksum value of the reconstructed source data item matches the checksum value of source data item, the system 180 allows access (i.e., opening) to the reconstructed source data item, providing the user (or administrator) of the computer system 140 with the ability to view and interact with the reconstructed source data item via appropriate application processes, executed, for example, by the OS 146.

Consider again the non-limiting illustrative example of the 6-byte first data item and the 1-byte second data item generated from the 8-byte source data item. Consider the 8-byte source data item to be a DOC file type (i.e., accessible via Microsoft® Word 1997-2007). Once the 6-byte first data item and the 1-byte second data item are combined by the system 180 to reconstruct the 8-byte source data item, the process winword.exe (i.e., an instance of the Microsoft® Word payload application) is called to open the 8-byte source DOC file. The 8-byte source DOC file is then presented for display to the user of the computer system 140, via, for example, a display screen or monitor.

The process 400 may then optionally move to blocks 414-418, which allows the user of the computer system 140 to edit, modify, or manipulate, and subsequently save any edits, modifications or manipulations made to the reconstructed source data item. Within the context of the aforementioned non-limiting illustrative example, blocks 414-418 allows the user of the computer system 140 to make changes to the 8-byte source DOC file, and save those changes in accordance with methodology of the data storage and retrieval module 170 described above with reference to FIG. 3.

In block 414, the system 180 modifies the reconstructed source data item in response to instructions issued by the user (or administrator) of the computer system 140. Such modifications include, but are not limited to, renaming the reconstructed source data item, editing the content of the reconstructed source data item, and changing the stored location of the reconstructed source data item.

Consider as an example a source data item TEST.DOC which has two data items generated therefrom. The first data item may be stored in the storage medium 152 and displayed to the user in the “My Documents” file directory, while the second data item may be stored on an externally connected USB based hard drive. Execution of blocks 402-412, in response to a user request to access the first data item, opens a reconstructed version of the source data item TEST.DOC and presents the reconstructed source data item to the user for display. In response to the user making edits and changes to the reconstructed source data item, and saving those changes, block 414 is performed by the system 180, which accepts the user initiated modifications to the reconstructed source data item.

The process 400 then moves to block 416, where the system 180 performs actions to generate new first and second data items from the modified reconstructed source data item. The actions performed by the system 180 in block 416 are similar to the actions performed in blocks 304 and 306, and should be understood by analogy thereto.

The process 400 then moves to block 418, where the system 180 stores the newly generated first and second data items (i.e., generated from the modified reconstructed source data item) in respective memory locations. For example, the first newly generated data item is stored in the storage medium 152, and the second newly generated data item is stored in the remote memory location 200. As should be understood, the actions performed by the system 180 in block 418 are similar to the actions performed in blocks 308 and 312, and should be understood by analogy thereto.

Note that if the modified reconstructed source data item has the same file name as the source data item, the first data item generated from the modified reconstructed source data item may overwrite (in memory) the first data item generated from the source data item, and the second data item generated from the modified reconstructed source data item may overwrite (in memory) the second data item generated from the source data item.

Further note that during modification of the reconstructed source data item (i.e., block 414), the reconstructed source data item may reside in volatile memory (e.g., RAM) on the computer system 140. Upon completion of the modification of the reconstructed source data item, the action of saving the modifications, as initiated by a user of the computer system 140, may remove the reconstructed source data from volatile memory, or the reconstructed source data item may be naturally removed from volatile memory upon rebooting of the computer system 140.

Note that although the operation of the system 180 has been described within the context of a non-limiting illustrative example of 8-byte data items, the system 180 is operative to perform the data storage and retrieval processes, in accordance with the methodology of the data storage and retrieval module 170 as described herein, for data items of sizes on the order of hundreds of bytes, kilobytes, megabytes, and larger.

Although the embodiments described thus far have pertained to the data storage and retrieval module 170 being a single module which performs actions for partitioning and storing data items as described, for example, with reference to FIG. 3, as well as separate actions for retrieving data items as described, for example, with reference to FIG. 4, other embodiments are possible, in which the data storage and retrieval module 170 includes a first module for performing the data item retrieval actions, and a separate second module for performing the data item partition and storage actions.

Although the embodiments described thus far have been illustrated, by way of non-limiting examples, to source data items being partitioned into two different subsets of data with each subset being retained in a separate generated data item (i.e., first and second generated data items), other embodiments are possible in which a single source data item is partitioned into three or more subsets. In such embodiments, a first subset of data (i.e., the portion of data of the source data item included in a first one of the generated data items) may be a majority portion of the data of the source data item, while a second and third subset of data (i.e., the portions of data of the source data item included in a second and third of the generated data items) may be a minority portion of the data of the source data item. The first data item may be stored in the storage medium 152, while both the second and third data items are stored in the remote memory location 200. Further, the second and third data items may be stored in the same memory location remote from the storage medium 152 (e.g., both stored in the data storage device 120) or may be stored in separate memory locations storage medium 152. For example, the first data item may be stored in the storage medium 152, the second data item may be stored in the data storage device 120, and the third data item may be stored on the remote server 130.

Note that a single remote memory location 200 may be used to store generated second data items (i.e., second subsets of data from source data items) which have corresponding first data items (i.e., first subsets of data from source data items) which are stored on multiple computer systems. For example, consider embodiments of the present disclosure performed in a non-network setting in which the remote memory location 200 is implemented as the data storage device 120. The data storage device 120 may include a first generated second data item, a second generated second data, and a third generated second data item. The first generated second data item may correspond to a first generated first data item that is stored in a local memory of a first computer system. Similarly, the second generated second data item may correspond to a second generated first data item that is stored in a local memory of a second computer system, and the third generated second data item may correspond to a third generated first data item that is stored in a local memory of a third computer system. Each of the three computer systems, which respectively store the three generated first data items, are operative in accordance with the description of the computer system 140, and therefore each of the three computer systems includes a respective data storage and retrieval module.

As mentioned above, the computer system 140 may be realized in various ways, including, for example, as an endpoint client, a file storage computer system, a computer cluster, a mobile communication device (e.g., smartphone), and a group of computers constituting an enterprise which are linked via a private network. In embodiments of the present disclosure in which the computer system 140 is realized as a mobile communication device (e.g., a smartphone), the data storage and retrieval methodology is preferably performed with the remote memory location 200 realized as the remote server 130. As such, the system 180, as installed and operative on the mobile communication device, stores the second data items on the remote server 130, and retrieves the stored second data items from the remote server 130. The remote server 130 may be accessible to the mobile communication device by browsing to web sites hosted by the remote server 130 over the network 110, or alternatively (or additionally) by accessing the remote server 130 via a data management application, installed on the mobile communication device as part of the system 180.

Although the embodiments described thus far, when performed over a network, have pertained to a remote memory location implemented as a remote server (e.g., a cloud server), other network based embodiments are possible, in which the remote memory location is installed on a remote computer system (i.e., a computer system remotely located from the computer system 140). In such embodiments, the computer system 140 and the remote computer system perform file sharing processes in order to store and retrieve data items.

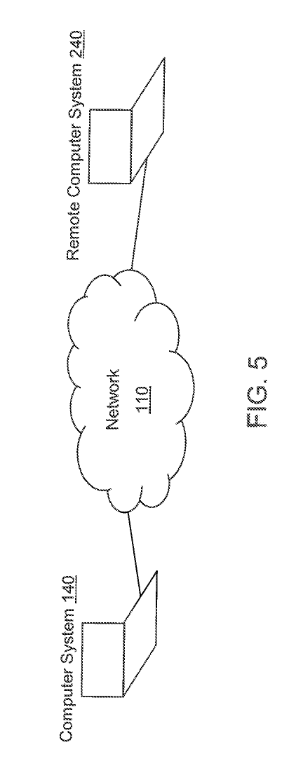

FIG. 5 shows an illustrative example environment in which such an embodiment may be performed. The illustrative example environment sown in FIG. 5 is generally similar to the environment shown in FIG. 1, with a remote computer system 240 functioning as the remote memory location 200. In such an embodiment, the remote computer system 240 includes similar components and modules of the computer system 140, as described with reference to FIG. 2. As such, the remote computer system 240 includes a system 280 that includes a data storage and retrieval module 270.

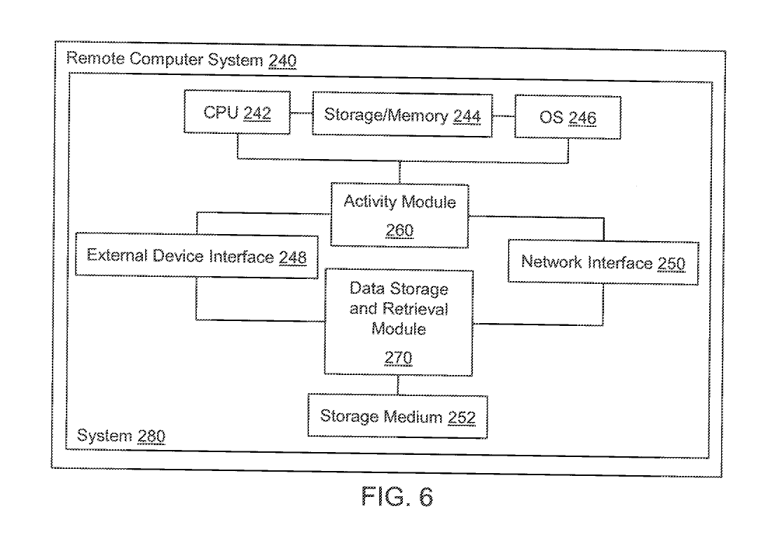

FIG. 6 shows the remote computer system 240 and the system 280 therein, as an architecture, with the data storage and retrieval module 270 incorporated into the system 280 of the remote computer system 240. The components and operation of the system 280 is similar to that of the system 180, and should be understood by analogy thereto, unless expressly stated otherwise. The components and operation of the data storage and retrieval module 270 is similar to that of the data storage and retrieval module 170, and should be understood by analogy thereto, unless expressly stated otherwise. The remote computer system 240 includes a CPU 242, storage/memory 244, OS 246, network interface 250, and a storage medium 252. The remote computer 240 may also include an activity module 260 and an external device interface 148. These components of the remote computer system 240 are generally similar to the correspondingly named components of the computer system 140, and perform functions and operations similar to those correspondingly named components, and should be understood by analogy thereto unless expressly stated otherwise. All components of the remote computer system 240 and/or the system 280 are connected or linked to each other (electronically and/or data), either directly or indirectly.

In the embodiments described with reference to FIGS. 5 and 6, the remote memory location (i.e., the memory location remote from the storage medium 152), may be implemented as the storage medium 252. Note that the remote memory location may alternatively be implemented as a peripheral data storage device removably connected to the remote computer system 240.

In the embodiments described with reference to FIGS. 5 and 6, the computer system 140 functions as the main distributor of the generated data items. In other words, the system 180, as installed on the computer system 140, performs the process 300 for decomposing, dividing, splitting, fragmenting, or otherwise partitioning source data items into first and second generated data items, and subsequently storing those generated data items in separate memory locations (i.e., the storage medium 152 and the storage medium 252), as described above with reference to FIG. 3.

As described above, the first data item includes the majority portion of the data of the source data item, and the second data item includes the remaining minority portion of the data of the source data item. The first data item is stored in local memory on the computer system 140 (i.e., in the storage medium 152), while the second data item is transmitted to the remote computer system 240 for storage in the storage medium 252. As mentioned above, the system 180 stores the memory address reference (i.e., pointer) information of the location of the second data item, and also generates information associating the generated data items with each other which also includes information pertaining to the structure and content of the source data item, such as, for example, checksum information. Such information may be stored as logged listings, in the form of files, tables or database entries, pertaining to all generated data items derived from the same source data item, and may be referred to interchangeably as tracking information.

The tracking information may further include network information associated with the remote computer system 240, including, but not limited to, the IP address of the remote computer system 240, and the upload port number of the remote computer system 240.

When performing the process for retrieving and reconstructing data items, as described with reference to FIG. 4, the computer system 140 operates as the main downloading computer, and requests the remaining portions of the required data from the remote locations, namely the remote computer system 240. In other words, when the computer system 140 requests access to a data item (as in block 402), the system 180 identifies the second data item being necessary to reconstruct the source data item, and requests access to the second data item that is stored in the remote memory location (i.e., the storage medium 252). The remote computer system 240 functions as a seed data item source which provides the requested data item portion (i.e., the second generated data item) to the computer system 140, which operates as a leech computer.

Note that the computer system 140 may share some or all of the information necessary for performing the data item reconstruction process, illustrated in FIG. 4, with the remote computer system 240 or other computer systems used by the user of the computer system 140. As such, a user of the remote computer system 240 may also request access to the source data item, by initiating the execution of the process 400, as performed by the system 280, on the remote computer system 240. In this way, the computer system 140 may function as a seed data item source which provides the requested data item portion (i.e., the first generated data item) to the remote computer system 240, which operates as a leech computer.

Note that in such configurations, the computer system 140 may prevent the remote computer system 240 from making the first data item available for download to other computer systems linked to the computer systems 140 and 240 over the network 110. Also note that such embodiments may be performed with multiple remote computer systems, each remote computer system storing a different minority portion of data of the source data item in non-volatile memory (i.e., two or more generated data items having subsets of data being minority portions of the data of the source data item).

In the embodiments described with reference to FIGS. 5 and 6, the transfer of data items between the computer system 140 and the remote computer system 240 (or systems), as data packets, is performed using a communication protocol, such as, for example, a TCP peer protocol.

As should be apparent to one of skill in the art, the embodiments of the present disclosure, as described thus far, may be implemented in a variety of ways. For example, as discussed above, the methods and systems of such embodiments may be implemented on endpoint clients and/or remote memory locations (e.g., remote server(s), data storage device(s), etc.). In addition, the methods and systems of such embodiments may be implemented by modifying or augmenting the architecture of certain types of clustered file systems, such as, for example, DFS architectures. For example, such modification or augmentation may include altering the program or system code of a DFS to perform the methods and systems of the above described embodiments.

Although the embodiments described thus far, when performed over a network, have pertained to multiple remote memory locations storing different subsets of data generated from a source data item, other embodiments are possible in which source data items are fragmented and reconstructed, via an email exchange server and/or an additional data server, between two computer systems.

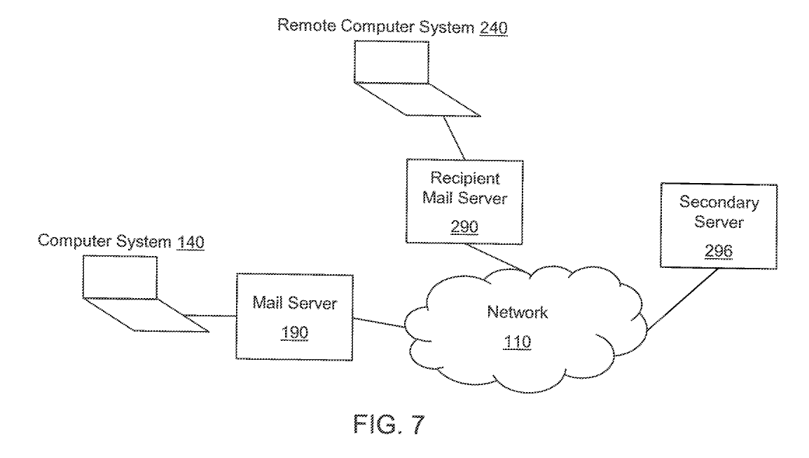

Refer now to FIG. 7, an illustrative example environment in which such embodiments of the present disclosure may be performed. The computer system 140, as in previously described embodiments, is linked to the network 110. A mail (i.e., electronic mail or e-mail) server 190 is linked to the computer system 140 and the network 110, and provides a data communication link for sending emails from the computer system 140 to recipient computer systems, via the network 110. A remote computer system 240, operating as a recipient computer system for receiving data from the computer system 140, is also linked to the network 110. A mail (i.e., electronic mail or e-mail) server 290 is linked to the remote computer system 240 and the network 110, and provides a data communication link for receiving email from the computer system 140 via the network 110. Both the computer system 140 and the remote computer system 240 are linked to a secondary server 296, via the network 110, which facilitates an additional exchange of data packets between the computer system 140 and the remote computer system 240, over the network 110, as will be described in further detail in subsequent sections of the present disclosure. The mail servers 190 and 290 preferably operate using simple mail transfer protocol (SMTP). The secondary server 296 may be, for example, an SMTP based proxy server, a file transfer protocol (FTP) server, an agent, a downloader, or any other entity utilizing network based protocols used for transferring data items between computer systems over a network.

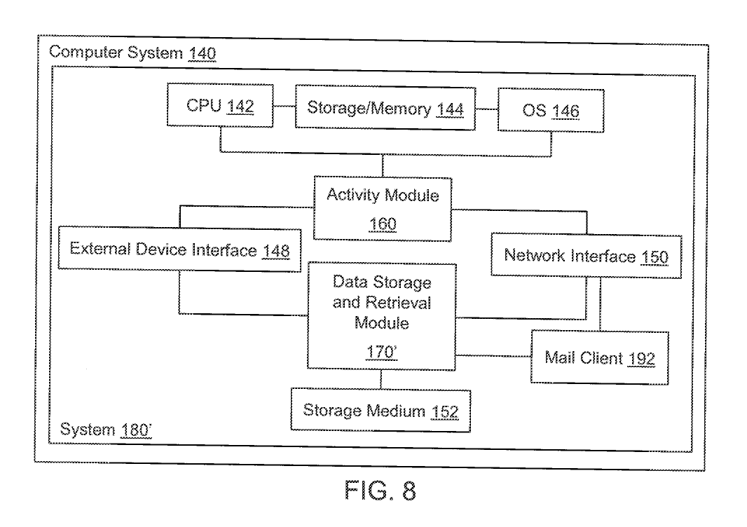

As with the previously described embodiments, the computer system 140 includes a system 180′, having a data storage and retrieval module 170′ incorporated therein. FIG. 8 shows the computer system 140 and a system 180′ therein, as an architecture, with a data storage and retrieval module 170′ incorporated into the system 180′ of the computer system 140. The components and operation of the system 180′ is similar to that of the system 180, and should be understood by analogy thereto, unless expressly stated otherwise. The components and operation of the data storage and retrieval module 170′ is similar to that of the data storage and retrieval module 170, and should be understood by analogy thereto, unless expressly stated otherwise. The computer system 140 further includes a mail client 192 that is, for example, any e-mail client used on a computer system for exchanging e-mail with other computer system. The mail client 192 may be implemented as, for example, Microsoft® Outlook, or various web browser based e-mail clients.

The remote computer system 240 includes similar components and modules of the computer system 140, as described with reference to FIG. 8. As such, the remote computer system 240 includes a system 280′ that includes a data storage and retrieval module 270′.

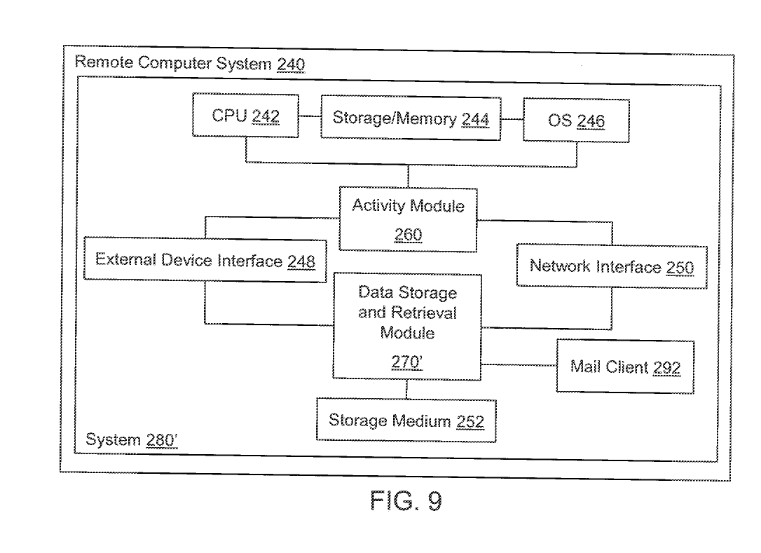

FIG. 9 shows the remote computer system 240 and the system 280′ therein, as an architecture, with the data storage and retrieval module 270′ incorporated into the system 280′ of the remote computer system 240. The components and operation of the system 280′ is similar to that of the system 180′, and should be understood by analogy thereto, unless expressly stated otherwise. The components and operation of the data storage and retrieval module 270′ is similar to that of the data storage and retrieval module 170′, and should be understood by analogy thereto, unless expressly stated otherwise. The remote computer system 240 includes a CPU 242, storage/memory 244, OS 246, network interface 150, and a storage medium 252. The remote computer 240 may also include an activity module 260 and an external device interface 148. These components of the remote computer system 240 are generally similar to the correspondingly named components of the computer system 140, and perform functions and operations similar to those correspondingly named components, and should be understood by analogy thereto unless expressly stated otherwise. The remote computer system 240 further includes a mail client 292 that is, for example, any e-mail client used on a computer system for exchanging e-mail with other computer system. The mail client 292 may be implemented as, for example, Microsoft® Outlook, or various web browser based e-mail clients. All components of the remote computer system 240 and/or the system 280′ are connected or linked to each other (electronically and/or data), either directly or indirectly.

The systems 180′ and 280′ cooperate to ensure the secure transmission of data items from the computer system 140 to the remote computer system 240. The system 180′, similar to the system 180, performs operations on source data items to decompose, divide, split, fragment, or otherwise partition the source data item into multiple subsets of data (i.e., generate first and second data items from the source data item. The system 180′ then transmits the generated data items for receipt by the system 280′, which performs operations to reconstruct the source data item from the generated data items.

In an exemplary series of processes, the system 180′ receives a request to attach a source data item to an email addressed to a recipient. The request may be initiated by a user of the computer system 140 selecting a source data item to attach to the email. In response to the request, the system 180′, via the data storage and retrieval module 170, operates on the source data item to generate two (or more) data items. As with previously described embodiments, the first generated data item includes a first subset of the data of the source data item, and the second generated data item includes a second subset of the data of the source data item that is different from the first subset.

As with previously described embodiments, the first data item preferably includes a majority portion of the data of the source data item, and is therefore preferably of a larger size than the second data item.

The system 180′, via for example the mail client 192, attaches the first data item to the email. The system 180′ then instructs the mail client 192 to transmit the email, with the first data item as an attachment to the transmitted email. The email is transmitted from the mail client 192, via the network interface 150, to the mail server 190 and over the network 110, to the recipient mail server 290, where the remote computer system 240 receives and accesses the transmitted email via the mail client 292. Subsequently or in parallel to the email transmission of the first generated data item, the system 180′ transmits the second generated data item to the secondary server 296, via the network 110. The transmission of the second generated data item to the secondary server 296 includes uploading the second generated data item to the secondary server 296.

In addition to the first subset of data, the first generated data item may include information indicating that a second generated data item (i.e., the second generated data item) is required in order to access (i.e., open) the source data item, as well as information associating the first and second data item with each other. As previously described, the information may be included as metadata or header data. The information may include a mapping which indicates which portions of data in the first and second data items correspond to which subsets of data of the source data item. Furthermore, the information may provide an instruction, link or URL, indicative of the location of the second generated data item. Such information may also include encryption and decryption information, similar to as discussed above with reference to FIGS. 1-4. Such information may be provided in a file separate from the first generated data item, or may be included as part of the first generated data item. In other words, the first generated data item, or an information file linked to the first generated data item, may provide instructions to the recipient system 280′ indicating that the second data item requires downloading from the secondary server 296 in order to access (i.e., open) the source data item.

Upon receipt and access of the transmitted email by the remote computer system 240, the system 280′ accesses first generated data item, attached to the received email. The system 280′ analyzes the information, provided in the first generated data item, indicative of the location of the second generated data item.

Based on the analyzed information, the system 280′ downloads the second generated data item, from the secondary server 296, and subsequently accesses the downloaded second generated data item. As mentioned above, the information in the first generated data item includes instructions indicating which portions of data in the first and second data items correspond to which subsets of data of the source data item.

The system 280′ then combines, for example, via concatenation, the subsets of data in the first and second generated data items to effectively generate a reconstructed rendition of the source data item from which the subsets of data (i.e., the first and second data items) were generated. The system 280′ may then transmit an acknowledgement message to the system 180′ indicative of successful reconstruction of the source data item.

As a result of the processes performed by the systems 180′ and 280′, the first and second generated data items are transmitted from the computer system 140, to the remote computer system 240, over separate network routes utilizing different network entities and protocols.

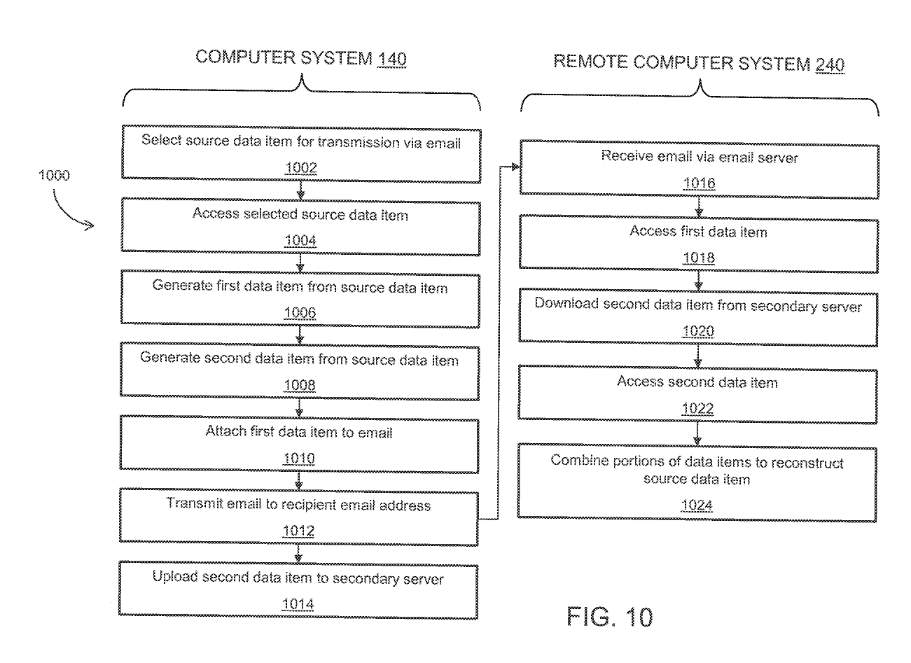

Attention is now directed to FIG. 10 which shows a flow diagram detailing a computer-implemented process 1000 in accordance with embodiments of the disclosed subject matter. This computer-implemented process includes an algorithm for fragmenting and reconstructing a source data item, via an email exchange server and/or an additional data server, between the computer system 140 and the remote computer system 240. Reference is also made to the elements shown in FIGS. 7-9. The process and sub-processes of FIG. 10 are computerized processes performed by the systems 180′ and 280′ including, for example, the CPU 142 and the CPU 242 and associated components, such as the data storage and retrieval modules 170′ and 270′. The aforementioned processes and sub-processes are for example, performed automatically, but can be, for example, performed manually, and are performed, for example, in real-time.

The process 1000 begins at block 1002, where a source data item is selected for attachment to an email, composed on the email client 192 and addressed to a recipient email address of a user of the remote computer system 240. The process 1000 then moves to block 1004, where the system 180′ accesses the source data item in order to decompose, divide, split, fragment, or otherwise partition the source data item into two subsets of data. The system 180′ reads the header and data content of the source data item, and determines the structured format of the source data item. Information pertaining to the structured format of the source data item may then be logged, for example, by the activity module 160 as instructed by the system 180′, and stored in a memory or database of the computer system 140.

The process 1000 then moves to block 1006, where the system 180′ performs actions to generate a first data item from the source data item. As discussed above, the first data item preferably includes a subset of the data of the source data item that includes a majority portion of the data of the source data item.

The process 1000 then moves to block 1008, where the system 180′ performs actions to generate a second data item from the source data item. As discussed above, the second data item preferably includes a subset of the data of the source data item that includes a minority portion of the data of the source data item. The exact proportions of the subsets of the data contained in the generated data items may be selected in accordance with user configured parameters of the system 180′.

As discussed above, the first generated data item includes information, in addition to the first subset of data of the source data item, indicating that the second generated data item is required in order to access (i.e., open) the source data item. Such information may include a mapping which indicates which portions of data in the first and second data items correspond to which subsets of data of the source data item. Furthermore, the information may provide an instruction, link or URL, indicative of the location of the second generated data item. In addition, the information may include a checksum function for generating checksum values, as well as the checksum value obtained using the source data item as input to the checksum function.

The process 1000 then moves to block 1010, where the system 180′ attaches the first data item (generated in block 1006) is to the composed email. The process 1000 then moves to block 1012, where the system 180′ transmits the email, with the first data item included as an attachment, to the recipient email address. The transmission of the email by the system 180′ is performed, for example, by the mail client 192, over the network 110 via the mail server 190.

The process 1000 then moves to block 1014, where the system 180′ transmits the second data item (generated in block 1008), via for example upload over the network 110, to the secondary server 296. Note that block 1014 may be performed prior to or in parallel with (i.e., concurrently) blocks 1010 and 1012.

As a result of the execution of block 1012, the process 1000 also moves to block 1016, where the system 280′ receives the email transmitted by the system 180′. The receipt of the email by the system 280′ is performed, for example, by the mail client 292, over the network 110 via the recipient mail server 290. As a result of the receipt of the email, by the system 280′, the system 280′ also receives the first data item (generated in block 1006).

The process 1000 then moves to block 1018, where the system 280′ accesses (i.e., opens) the first data item. As a result of the access of the first data item, by the system 280′, the system 280′ additionally analyzes the information, provided in the first generated data item, indicative of the location of the second generated data item.

The process 1000 then moves to block 1020, where the system 280′, based on the information analyzed in block 1018, receives the second generated data item. The second data item may be received, by the system 280′, for example, via download from the secondary server 296, which as described above, may be, for example, an SMTP based proxy server, a file transfer protocol (FTP) server, an agent, a downloader, or any other entity utilizing network based protocols used for transferring data items between computer systems over a network.

The process 1000 then moves to block 1022, where the system 280′ accesses the received second data item, to obtain the appropriate portion of the second data item required for reconstructing the source data, as indicated in the information provided in the first data item.

The process 1000 then moves to block 1024, where the system 280′ operates on the accessed first and second data items to reconstruct the source data item from which the first and second data items were generated. The operations performed by the system 280′ in block 1024 include determining which portions of data in the first and second data items should be combined together to render the reconstructed source data item. As mentioned above, the system 280′ may analyze the information associating the generated data items with each other which indicate which portions of data in the first and second data items correspond to which subsets of data of the source data item. In this way, the system 280′ is able to combine, for example, via concatenation, those subsets of data to effectively generate a reconstructed rendition of the source data item from which the subsets of data (i.e., the first and second data items) were generated.

The operations performed by the system 280′ in block 1024 may also include generating a checksum value for the reconstructed source data item by using the reconstructed data item as input to the checksum function used to generate the checksum value of the source data item. As mentioned above, the checksum function and checksum value of the source data item may be part of the information included in the first data item. Although not shown in FIG. 10, if the checksum value of the reconstructed source data item does not match the checksum value of source data item, the system 280′ may provide an indication to the system 180′, via transmission of an error message over the network 110, that a reconstruction error occurred while attempting to reconstruct the source data item from the generated data items.

If the checksum value of the reconstructed source data item matches the checksum value of source data item, the system 280′ allows access (i.e., opening) to the reconstructed source data item, providing the user (or administrator) of the remote computer system 240 with the ability to view and interact with the reconstructed source data item via appropriate application processes, executed, for example, by the OS 146. The system 280′ may then provide an indication to the system 180′, via transmission of an acknowledgement message over the network 110, of successful reconstruction of the source data item.

Note that when the reconstructed source data item is accessed (i.e., opened) by the system 280′, the reconstructed source data item may reside in volatile memory (e.g., RAM) on the remote computer system 240. At no point, however, is the reconstructed source data item retained in a non-volatile memory (e.g., the storage medium 252) of the remote computer system 240.

As should be apparent to one skilled in the art, the process 1000 may be modified such that a source data item is decomposed, divided, split, fragmented, or otherwise partitioned into more than two subsets of data. For example, blocks 1006-1008 may be modified such that three or more data items are generated from a source data item. Ideally, one of the generated data items includes a majority portion of the data of the source data item, while the remaining generated data items include minority portions of the data of the source data item. Furthermore, block 1014 may be modified such that the generated data items that include the minority portions of the data, are uploaded to different secondary servers (each one operative according to the description of the secondary server 296) or the secondary server 296.

Although not explicitly shown in FIG. 10, the process 1000 may include steps for encrypting and decrypting any or all of the generated data items, similar to as discussed above with reference to FIGS. 1-4. For example, the second generated data item may be encrypted subsequent to the execution of block 1008 and prior to the execution of block 1014. As such, if the second generated data item is encrypted, the execution of block 1022 may include processes for decrypting the encrypted second generated data item.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present invention. The non-transitory computer readable (storage) medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes, and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes, and is not intended to limit any of such computer-implemented methods disclosed herein.

The flowcharts and block diagrams in the Figures illustrate the architecture, functionality, and operation of possible implementations of systems, methods and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

The above-described processes including portions thereof can be performed by software, hardware and combinations thereof. These processes and portions thereof can be performed by computers, computer-type devices, workstations, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A method for storing data items, comprising:
generating at least a first and a second data item from a source data item, the first data item including a first subset of data of the source data item and the second data item including a second subset of data of the source data item, the first and second subsets of data being different from each other, and both of the first and second subsets of data being necessary to access the source data item; and
storing the first data item in a first data storage medium and the second data item in a second data storage medium that is remotely located from the first data storage medium.

2. The method of claim 1, wherein the first data storage medium is deployed on an endpoint client.

3. The method of claim 1, wherein the second data storage medium includes a remote server.

4. The method of claim 1, wherein the second data storage medium includes an external device operative to removably couple to the first data storage medium via a physical interface.

5. The method of claim 1, wherein the first subset of data includes a majority of data of the source data item.

6. The method of claim 1, wherein the second subset of data includes a minority of data of the source data item.

7. The method of claim 1, wherein the source data item includes header information, and wherein each of the first and second data items includes header information derived from the source data item header information.

8. The method of claim 1, further comprising:
reconstructing the source data item by combining at least a portion of data of the first data item with at least a portion of data of the second data item.

9. A computer system for storing data items, comprising:
a storage medium for storing computer components; and
a computerized processor for executing the computer components comprising:
a computer module configured for:
generating at least a first and a second data item from a source data item, the first data item including a first subset of data of the source data item and the second data item including a second subset of data of the source data item, the first and second subsets of data being different from each other, and both of the first and second subsets of data being necessary to access the source data item; and
storing the first data item in a first data storage entity and the second data item in a second data storage entity that is remotely located from the first data storage entity.

10. The computer system of claim 9, wherein the storage medium and the computerized processor are deployed on an endpoint client.

11. The computer system of claim 10, wherein the first data storage entity is deployed on the endpoint client.

12. The computer system of claim 11, further comprising:
a data storage medium deployed on the endpoint client, wherein the first data storage entity is implemented as the data storage medium.

13. The computer system of claim 10, further comprising:
a data item allocation table, installed on the endpoint client, that includes a memory address reference to the second data storage entity.

14. A method for reconstructing data items, comprising:
receiving a request to access a first data item that includes a first subset of data of a source data item, the first data item being stored in a first data storage medium;
identifying a second data item, based on the request to access the first data item, the second data item being stored in a second data storage medium remotely located from the first data storage medium, and the second data item including a second subset of data of the source data item that is different from the first subset of data, and both of the first and second subsets of data being necessary to reconstruct the source data item;
verifying an authorization to access the first and second data items; and
should access to both first and second data items be authorized, combining at least a portion of data of the first data item with at least a portion of data of the second data item to generate a reconstructed rendition of the source data item.

15. The method of claim 14, wherein the first data storage medium is deployed on an endpoint client.

16. The method of claim 14, wherein the identifying the second data item includes:
analyzing a memory address reference to the second data storage medium.

17. The method of claim 14, further comprising:
modifying the reconstructed rendition of the source data item generate a modified data item.

18. The method of claim 17, further comprising:
generating a new first and second data item from the modified data item, the new first data item including a first subset of data of the modified data item and the new second data item including a second subset of data of the modified data item; and
storing the new first data item in the first data storage medium and the new second data item in the second data storage medium.

19. The method of claim 18, wherein the storing includes: overwriting the first data item with the new first data item, and overwriting the second data item with the new second data item.

20. The method of claim 14, further comprising:
establishing a data communication link between the first data storage medium and the second data storage medium.
